(19) United States
(12) Patent Application Publication
(10) Pub. No.: US 2005/0262876 A1
(43) Pub. Date: Dec. 1, 2005

(54) Method for plasma overcladding a fluorine-doped optical fiber preform tube

(75) Inventors: Pierryle Jourdier, Paris (FR); Claire Wane Nguila, Paris (FR); Ludovic Fleury, Bois D'Arcy (FR)

Correspondence Address: SUGHRUE MION, PLLC, 2100 PENNSYLVANIA AVENUE, N.W., SUITE 800, WASHINGTON, DC, 20037, US

(73) Assignee: DRAKA COMTEQ B.V.

(21) Appl. No.: 11/010,439

(22) Filed: Dec. 14, 2004

(30) Foreign Application Priority Data
Dec. 15, 2003 (FR) 0314756

(51) Int. Cl. C03B 37/018

(52) U.S. Cl. 65/391; 65/397; 65/398; 65/421

(57) ABSTRACT

The field is that of methods for providing fiber-optic final preforms obtained by external plasma overcladding build-up around a primary preform. The method involves providing a final preform starting from a primary preform by external plasma deposition of silica grain over a primary preform, the outer peripheral layer of the primary preform consisting of a fluorine-doped silica tube. The build-up process involves forming a first overcladding using fluorine-doped synthetic silica grain followed by a second overcladding step using natural silica grain. The optical fibers obtained and their associated optical fiber preforms are also disclosed.

The invention relates to the field of optical fibers, optical fiber preforms and methods for producing final optical fiber preforms obtained by external plasma deposition around a primary preform.

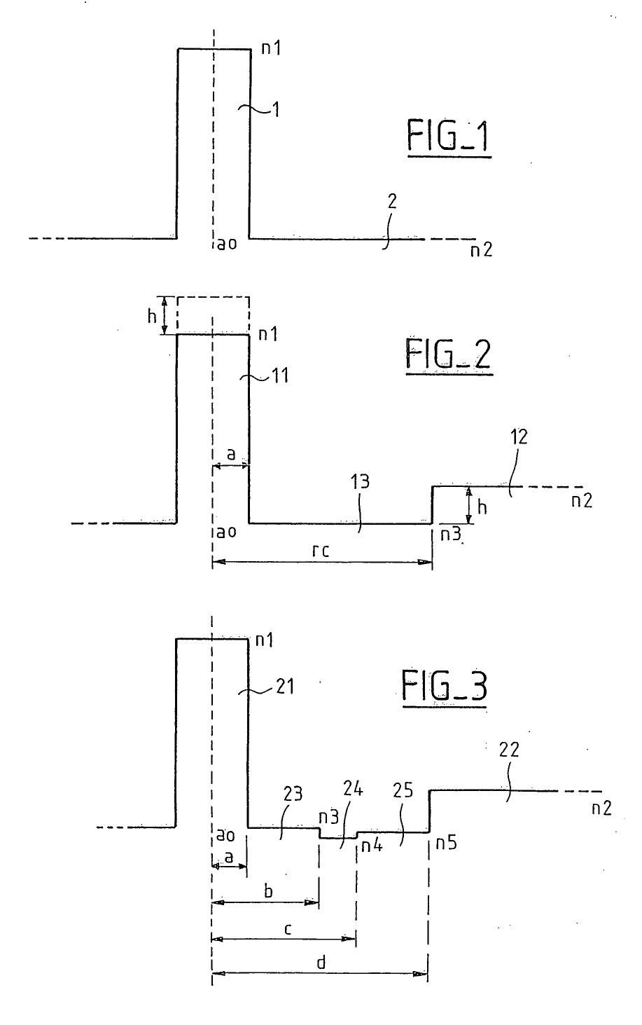

A conventional optical fiber, for example a single mode fiber (SMF) has a refractive index profile that varies with its radius starting from the center of the fiber which typically is as illustrated in FIG. 1. A core 1 of refractive index n1 is surrounded by a cladding 2 of refractive index n2. The index n1 of core 1 is greater than the index n2 of the cladding 2 so that light will propagate inside the optical fiber. As the cladding 2 is in undoped silica, the core 1 should be of silica doped with a dopant that increases the refractive index of the silica. Habitually, this is germanium. As attenuation deteriorates as the percentage of germanium increases, the optical fiber shown in FIG. 1 generally has too high an attenuation.

To improve fiber attenuation, it is known to set out to decrease the amount of germanium in the core 1 of an optical fiber. However, as a difference between the core and cladding refractive indices is determined by the desired propagation characteristics of the optical fiber, this makes it necessary to decrease cladding refractive index, which will now be of silica doped with a dopant that reduces refractive index. This dopant is habitually fluorine. To ensure now that the optical fiber is not too sensitive to microbending and consequently does not exhibit too high microbending losses, this fluorine-doped silica cladding, of refractive index lower than that of silica, needs to be brought up to a critical radius the value of which depends on the core radius. For reasons of preform production casts, beyond this critical radius, the cladding is again in undoped silica, as providing doped silica layers in a preform is more costly than providing undoped silica layers. The optical fiber obtained is illustrated in FIG. 2. This optical fiber comprises a core 11 of radius ‘a’ of germanium-doped silica with a refractive index n1 greater than that of silica, an inner cladding 13 of radius rc in fluorine-doped silica having a refractive index n3 lower than that of silica and surrounding the core 11, an outer cladding 12 of undoped silica having a refractive index n2 and surrounding the inner cladding 13. The amount ‘h’ by which refractive index around core 11 is decreased with respect to outer cladding 12, is encountered where inner cladding 13 is buried inside outer cladding 12. Provided that the radius rc is at least equal to the critical radius, the optical fiber obtained does not exhibit any deterioration in microbending losses. We have taken the example of a standard optical fiber the core 11 of which is uniform in section; nevertheless ether optical fibers, for example of the offset dispersion type having several core sections same of which may be buried, can also be envisaged.

The inner cladding 13 is constituted by fluorine-doped silica.

In the first prior art discussed disclosed for example in Patent Abstracts of Japan JP 55100233, this inner cladding 13 can consist of a fluorine-doped silica tube surrounding the doped core of the primary preform. Either the ratio between outer tube radius and outer core radius is relatively high and the primary preform is too expensive, or the ratio between the outer tube radius and outer core radius is fairly small and the optical fiber obtained by pulling the final preform after adding a low quality silica tube by a sleeving operation is too sensitive to microbending and, consequently, exhibits too high microbending losses. This JP 55100233 relates to a method of manufacturing a preform, wherein a doped quartz glass rod as core material is inserted into synthetic quartz glass tube of high purity and they are made solid by heating to a high temperature with an external heat source to obtain a semi-preform rod. The preform thus obtained is further put into a low-purity quartz glass tube such as natural quartz glass tube and made solid by heating to a high temperature with an external heat source, thus producing a preform rod. This Japanese document does not relate to a method for external plasma cladding buildup.

In the second prior art, concerning primary preforms obtained by chemical vapor deposition (CVD) covering MCVD, FCVD deposition and ether depositions of the same type, the inner cladding 13 can be constituted by a fluorine-doped silica tube inside of which an optical cladding of the CVD type bas been deposited, the outer cladding 12 being constituted from the natural silica grain the refractive index of which is appreciably greater than the refractive index of the fluorine-doped silica tube. A core, generally germanium doped, is deposited inside the optical cladding by CVD-type deposition. Again, like the case above, either the ratio between the outer tube radius and outer core radius is relatively high and the primary preform is too expensive, or the ratio between the outer tube radius and outer core radius is fairly small and the fiber obtained by fiber pulling of the final preform after adding a low quality silica tube by a sleeving operation is too sensitive to microbending and consequently has too high microbending losses.

In the invention, part of the inner cladding 13, that part located externally of and on the outside of the fluorine-doped silica tube is obtained by deposition from synthetic grain in fluorine-doped silica, which is distinctly less costly than providing layers by CVD or the use of a fluorine-doped silica tube of appreciable cross-section, making it possible to provide an inner cladding 13 of outer radius sufficiently great compared to the outer radius of the primary preform core to obtain an optical fiber that is relatively insensitive to microbending while keeping production casts at a reasonable level. Regarding the outer cladding 12, this is obtained by overcladding from natural silica grain deposition, as using fluorine-doped synthetic silica grain for the complete final preform would be too expensive. It is the fact of overcladding the primary preform in a two-stage operation, first using fluorine-doped synthetic silica grain followed by natural silica grain, which allows an optical fiber simultaneously having low and consequently good attenuation and low sensitivity to microbending to be obtained, and which is simultaneously relatively inexpensive to produce.

U.S. 2002/0144521 relates to a method of manufacturing an optical fiber preform, the method comprising the following steps:
providing a substrate tube of silica doped with sufficient chlorine and doped with sufficient fluorine relative to the chlorine doping to obtain a refractive index that is lower than that of a natural silica;
depositing inner cladding and an optical core inside the substrate tube;
collapsing the substrate tube to form a primary preform; and
depositing outer cladding of said natural silica on the resulting primary preform.

Such outer deposition can be performed in various different ways, e.g. by plasma deposition, wherein grains of natural silica are deposited by gravity from a feed pipe which is moved in translation parallel to the primary preform, wherein the silica grains are fused and then vitrified at a temperature of about 2300° C. by means of the plasma.

The invention provides an original final preform, an overcladding method making it possible to obtain it, an optical fiber resulting from pulling the said final preform and an optical cable employing several fibers thus obtained.

The invention consequently provides a method for external plasma cladding buildup in which a final optical fiber preform is obtained by overcladding a primary preform with silica grains or crystals and a peripheral layer of the primary preform is constituted by a fluorine-doped silica tube, characterized in that the external plasma cladding buildup method comprises a first step of external plasma overcladding using synthetic fluorine-doped silica grain followed by a second step of overcladding using natural silica grain.

There is also provided a final optical fiber preform comprising a primary preform the peripheral layer of which is constituted by a fluorine-doped silica tube, an external plasma deposited overcladding layer surrounding said primary preform,

characterized in that said deposited overcladding layer comprises a first overcladding sub-layer obtained from fluorine-doped synthetic silica grain surrounding said tube, and a second overcladding sub-layer obtained from natural silica grain and which surrounds said first overcladding sublayer.

The invention will be better understood and other features and advantages will become more apparent from the description that follows taken in conjunction with the attached drawings, provided by way of example. In the drawings:

FIG. 1 is a diagram showing an example of optical fiber refractive index profile according to the prior art.

FIG. 2 is a diagram showing an example of refractive index profile for an optical fiber of the prior art and according to the invention.

FIG. 3 is a diagram showing an example of refractive index profile for a final optical fiber preform according to the invention.

FIG. 3 shows diagrammatically one example of refractive index profile for a final optical fiber preform according to the invention. On FIG. 3, like in FIGS. 1 and 2, the optical axis of the final preform or optical fiber is indicated by the dashed line ao. Radii I are given starting from the center of the final preform. The final optical fiber preform comprises, moving progressively from the center towards the outside, a core 21 of refractive index n1 and radius ‘a’, deposited by CVD-type deposition and germanium-doped, an inner cladding, an outer cladding 22 of refractive index n2, deposited by plasma silica deposition using natural silica grain, undoped, which will also be referred to as the second overcladding sublayer below. The inner cladding comprises, moving successively from the center towards the outside, an optical cladding 23 of index n3 and radius ‘b’, deposited by CVD-type deposition and fluorine-doped, a tube 24 in fluorine-doped silica having a refractive index n4 and radius ‘c’, a layer deposited by plasma silica deposition using fluorine-doped synthetic silica grain also referred to below as the first overcladding sublayer having a refractive index n5 and radius ‘c1’. The primary preform consists of core 21, optical cladding 23 and the tube 24.

The plasma overcladding deposition method builds up on a primary preform in order to obtain a final preform by silica grain deposition. The primary preform has an outer peripheral layer constituted by tube 24 in fluorine-doped silica. This peripheral layer of the primary preform is the most outer layer of the primary preform. The primary preform could for example be a cylinder obtained for example by VAD (vapor axial deposition) or OVD (outside vapor deposition) followed by a sleeving operation using a fluorine-doped silica tube. The primary preform is preferably obtained by CVD-type deposition inside a tube 24 in a fluorine-doped silica, like in the case illustrated in FIG. 3. The primary preform now comprises, moving outwardly from the center, a core 21 at least a part of which is doped, for example with germanium so as to provide a refractive index greater than that of silica, an optical cladding 23 deposited using fluorine-doped silica, and the tube 24 in fluorine-doped silica. The plasma overcladding deposition method comprises firstly, in an initial step, a first operation consisting in overcladding using fluorine-doped synthetic silica grain so as to obtain a first overcladding sublayer 25 followed, in a second overcladding operation by deposition using undoped natural silica grain so as to obtain the second overcladding sublayer 22. Both the first overcladding sublayer and second overcladding sublayer belong to the overcladding layer and preferably constitute the overcladding layer. The natural silica grain is generally undoped and is an inexpensive material, and natural silica grain to which a small amount of a dopant, provided its cast price is distinctly less than that of synthetic grain, could also be used for providing the second overcladding sublayer 22. In the overcladding method of the invention, two types of grain are employed: a fluorine-doped synthetic silica grain, the synthetic grain being of good quality and relatively inexpensive, and natural silica grain, this natural grain being less expensive but of inferior quality. The cast price of the natural grain employed is less than that of this synthetic grain employed, which gives its value to the invention. The price of the natural grain employed is generally several times less than that of the synthetic grain employed, thereby making the invention highly advantageous. The price of natural silica grain is habitually at least half that of synthetic silica grain, in particular fluorine-doped synthetic silica grain. Preferably, the second overcladding sublayer is made from fluorine-doped synthetic silica grain up to a critical final preform radius separating the overcladding sublayers one from the other, the term critical referring to the sensitivity to microbending of the optical fiber that will be obtained from this final preform while, beyond this critical radius, the second overcladding sublayer is built up from natural silica grain. The first overcladding sublayer can of course stop before or after this critical radius; the tradeoff between sensitivity to microbending of the fiber obtained and the cast price of the final preform compared to the prior art will nevertheless be substantially improved without however being fully optimized. Full optimization of this tradeoff is obtained when the said critical radius separates the first overcladding sublayer from the second overcladding sublayer. The final preform critical radius corresponds to a border or frontier between a region where light will propagate in the corresponding optical fiber and a region where light will not propagate in the corresponding optical fiber.

Preferably, in order for the first overcladding sublayer 25 to extend right up to around the critical radius for microbending sensitivity, the outside diameter of the first overcladding sublayer 25 is at least five times greater than the outside diameter of deposited core 21. Advantageously, the outside diameter of first overcladding sublayer 25 is around six times greater than the outside diameter of deposited core 21. Turning back now to FIG. 3, we can see a ratio d/a of around 6 with a ratio c/a substantially less than 6; in the prior art however, the absence of ‘d’ led to a ratio of c/a close to 6 for an equivalent quality, but for a distinctly higher cast price.

Preferably, the radial thickness of the first overcladding sublayer 25 is greater than half the outside radius of tube 24. This gives a value d-c which is greater than c/2. If the overcladding sub-layer 25 thickness is too small, the quality/price tradeoff gain even if present, will remain fairly small and consequently less valuable.

Preferably, the deposited core 21 is germanium-doped. Other dopants that increase core refractive index could optionally also be used. The whole deposited core 21 is advantageously germanium-doped so that its refractive index remains constantly greater than that of silica, like for example in the case where the final preform is designed to provide a standard single mode fiber after pulling.

The refractive indices of the optical cladding 23, of tube 24 and of the first overcladding sublayer 25 are preferably all fairly close to each other so that the refractive index profile of a fiber obtained after pulling the preform will neither show an annulus nor a dip which could deteriorate optical fiber microbending behavior. On FIG. 2, what we call an annulus would be an upward step while a dip would be a downward step. A downward step is however less serious than an upward step. The refractive indices n3, n4 and n5 may not all be on the same level as in FIG. 3, as viscosities are not completely identical. During fiber pulling, slight differences in refractive index and viscosity get balanced out and the profile obtained for the optical fiber resembles that in FIG. 2. The portions 23, 24 and 25 of the final preform will be substantially at the same level as each other over the optical fiber, small differences being able to remain provided that they do not substantially deteriorate the optical fiber microbending performance.

The invention also concerns the optical fiber obtained by pulling a final preform of the invention. Preferably, the portions of the index profile of the optical fiber respectively obtained from optical cladding 23, tube 24 and the first overcladding sublayer 25 all have the same refractive index, this being below that of silica. The optical fiber preferably concerned by the invention is one which is little sensitive to microbending, while having low attenuation.

The invention also concerns an optical fiber cable comprising several optical fibers according to the invention. Thanks to the absence of dips and, in particular upward steps in the optical fiber refractive index profile, no spurious mode (“mode parasite”) will propagate in these optical fibers.

1. A method for external plasma cladding buildup in which a final optical fiber preform is obtained by overcladding a primary preform with silica grain and a peripheral layer of the primary preform is constituted by a fluorine-doped silica tube, characterized in that the external plasma cladding buildup method comprises, a first step of external plasma overcladding using synthetic fluorine-doped silica grain, followed by a second step of overcladding using natural silica grain.

2. The external plasma overcladding method according to claim 1, wherein the primary preform is obtained by CVD-type deposition inside a fluorine-doped silica tube, and in that said primary preform comprises, from the center towards the periphery, a deposited core of which at least a part is doped so as to have a refractive index greater than that of silica, a deposited optical cladding in fluorinedoped silica, and then said tube.

3. The external plasma overcladding deposition method according to claim 1, wherein the price of the natural silica grain employed is several times lower than the price of the synthetic silica grain employed.

4. A final optical fiber preform comprising:
a primary preform the peripheral layer of which is constituted by a fluorine doped silica tube,
an external plasma deposited overcladding layer surrounding said primary preform, characterized in that said deposited overcladding layer comprises, a first overcladding sublayer obtained from fluorinedoped synthetic silica grain surrounding said tube,
and a second overcladding sublayer obtained from natural silica grain and which surrounds said first overcladding sublayer.

5. The final optical fiber preform according to claim 4, wherein said primary preform is obtained by CUD-type deposition inside a tube, and in that said primary preform comprises, from the center towards the periphery, a deposited core a part at least of which is doped so as to have a refractive index greater than that of silica, and a deposited optical cladding in fluorine-doped silica, and said tube.

6. The final optical fiber preform according to claim 5, wherein a refractive index of said optical cladding, of said tube and of said first overcladding sublayer are all close to each other so that the profile of refractive index of the optical fiber obtained by pulling said final preform will show no upward nor downward step able to deteriorate the microbending performance of said optical fiber.

7. The final optical fiber preform according to any one claim 5, wherein an outside diameter of said first overcladding sublayer is at least five times greater than an outer diameter of the deposited core.

8. The final optical fiber preform according to claim 7, wherein the outside diameter of the first overcladding sublayer is around six times greater than the outside diameter of the deposited core.

9. The final optical fiber preform according to claim 5, wherein the deposited core is germanium doped.

10. The final optical fiber preform according to claim 9, wherein the whole deposited core is germanium doped so that its refractive index remains constantly greater than the refractive index of silica.

11. The final optical fiber preform according to claim 4, wherein a radial thickness of the first overcladding sublayer is greater than half the outside radius of said tube.

12. An optical fiber obtained by pulling a final preform according to claim 4.

13. The optical fiber according to claim 12, wherein the portions of refractive index profile of said optical fiber respectively corresponding to said optical cladding, said tube and said first overcladding sublayer exhibit substantially the same refractive index being less than that of silica.

14. The optical fiber according to claim 12 wherein said optical fiber is relatively insensitive to microbending while showing low attenuation.

15. A fiber optics cable comprising several optical fibers according to claim 12, wherein no spurious mode propagates in said optical fibers.
